(19) United States
(12) Patent Application Publication
(10) Pub. No.: US 2014/0337957 A1
(43) Pub. Date: Nov. 13, 2014

(54) OUT-OF-BAND AUTHENTICATION

(71) Applicant: Dannie Gerrit Feekes, El Dorado Hills, CA (US)

(72) Inventor: Dannie Gerrit Feekes, El Dorado Hills, CA (US)

(21) Appl. No.: 14/272,487

(22) Filed: May 7, 2014

Related U.S. Application Data
(60) Provisional application No. 61/820,241, filed on May 7, 2013.

(51) Int. Cl. H04L 29/06

(52) U.S. Cl. CPC H04L 63/0853; H04L 63/0838
USPC 726/9

(57) ABSTRACT

In one aspect, the present disclosure is generally directed to a hardware token for completing an out-of-band authentication. In one embodiment, the hardware token performs a method that comprises: receiving an out-of-band encryption key from a client computing device; deriving a security credential that uniquely identifies the hardware token; transmitting the derived security credential and received out-of-band encryption key over the out-of-band communication channel to a network backend over a wireless network; receiving an in-band encryption key over the out-of-band communication channel; and transmitting the received in-band encryption key to the paired client computing device.

### CROSS-REFERENCE TO RELATED APPLICATIONS

This application claims the benefit of U.S. Provisional Patent Application No. 61/820,241 filed on May 7, 2013 which is herein incorporated by reference.

### BACKGROUND

The strength of a security paradigm is frequently described in terms of the number of authentication factors associated with a user that are verified. The three factors of authentication include a knowledge factor (“something only the user knows”) such as a username, password, or Personal Identification Number (“PIN”); a possession factor (“something only the user has”) such as a hardware token/device; and a inherence factor (“something only the user is”) such as a fingerprint, iris, or other biometric attribute. In a two-factor authentication schema, for example, at least two of the three factors associated with a user must be verified in order to grant access to a protected resource. As will become apparent in the description that follows, the efficacy of a security paradigm largely depends on the ways in which these authentication factors are verified.

The implementation of security is important in many domains and particularly in today's networked society in relation to implementation of transactions and logical access which may take place across communications networks. The most common authentication scheme today relies heavily on user names and static passwords. With the ever increasing number of data breaches and their resulting damage, it is clear that there are a number of security issues with the existing password based security paradigm. First, the number of accounts that a typical user is associated with and must remember security credentials (i.e. username and/or password) for is growing ever larger and this trend is unlikely to change. A user can only remember a limited number of different username/password pairs and has a tendency to re-use security credentials across different accounts. This creates a potential risk of correlation of the user's security credentials between different service providers. Second, hackers have proven successful in implementing a number social engineering and cracking techniques to steal a user's security credentials. Well-versed and sophisticated ‘phishing’ scams enable hackers to trick even security conscious users into giving up their security credentials. Third, the constant re-entry of security credentials in a variety of domains is not user friendly which diminishes the appeal, utility, and ultimately the security of a service providers offerings as users understandably avoid complex passwords and other techniques that assist in securing network resources. As a result, an arsenal of tools that are widely distributed in malware communities have been developed that are designed to ‘crack’ the security credentials of large numbers of users.

In addition to the drawbacks identified above, the existing methods of communicating security credentials is not sufficiently strong enough for important services that should be highly secure such as e-commerce, online banking, government portals, VPN access, corporate Intranet access, IP telephony, among others. By way of example, FIG. 1 shows a “two-factor” authentication system 100 currently implemented in a large number of environments to secure portals, VPNs, and/or corporate Intranet access, among others. In the exemplary system 100 depicted in FIG. 1, the user is provided with a hardware security token configured to generate a One Time Password (hereinafter “OTP”). In this instance, the hardware security token is a smart card 102 having a display 104 that presents an OTP value to the user upon activation of the button 106. However, one skilled in the art and others will recognize that hardware security tokens also take other form factors than cards. Moreover, a number of smart phones and other computing devices support applications that serve as a software-based security token having the same or similar functionality as a hardware token. In the example depicted in FIG. 1, the user accesses a corporate portal by navigating to an appropriate online location, namely the login page 108. To login and access the ‘secure’ resources of the corporate portal, the user provides a user name/password pair, and an OTP generated using the hardware token 102. These security credentials are entered into the appropriate fields of the login page 108 for authentication at the in-band authentication system 110 at the network backend 112. However, so called ‘man-in-the-middle’ attacks or other malware can compromise all of the security credentials entered into the login page 108 including the OTP generated using the hardware token 102. In the example depicted in FIG. 1, malware that infects a web browser or application by taking advantage of vulnerabilities in browser security to modify web pages, modify transaction content or insert additional transactions (in a completely covert fashion) have been widely distributed and used to hijack login sessions. One skilled in the art and others will recognize that FIG. 1 depicts just one exemplary ‘man in the middle’ attack. The security paradigm depicted in FIG. 1 can be compromised in many other ways than described here. These and other types of attacks compromise the in-band communication channel (i.e. browser-based Internet communication) that is leveraged to transmit a user's security credentials. The malware can be successful irrespective of whether security mechanisms such as SSL/PKI and/or whether one, two or three-factor authentication solutions are in place. In fact, many of the security protocols and multi-factor authentications schemas currently implemented today largely provide a false perception of security. The number of ‘factors’ of authentication that are implemented becomes irrelevant if the in-band communication channel (i.e. browser or application based Internet communication) is insecure.

Now with reference to FIG. 2, another “two-factor” authentication system 200 currently implemented by a number of institutions in allowing logical access (i.e. account login, password reset, and the like) will be described. This depicted system 200 utilizes an “out-of-band” communication channel to provide the user with a security credential such as an OTP. In this example, a user may utilize a general purpose computing device connected to the Internet, which connects to the primary or in-band communication channel on which the transaction will be conducted. Concurrently with a user initiating a transaction request, a network backend 202 and out-of-band authentication system 204 associated with the service provider may transmit an OTP (or other security credential such as a PIN number, username, etc.) in the SMS message 206 to the user's designated mobile phone 208. In the example depicted in FIG. 2, the wireless network 210 over which the SMS message is communicated constitutes the out-of-band communication channel. To complete a login, the user enters the requested credentials (e.g. username, password, and the OTP received in the SMS message 206) into the appropriate fields in the login page 212 or application and causes the credentials to be transmitted to the network backend 202 via the in-band communication channel (i.e. the Internet). Accordingly, all of the security credentials are provided or supplied in-band within the same communication channel as the one on which the transaction or logical access is conducted. However, as described above with reference to FIG. 1, the communication of all security credentials in-band in this way represents a fundamental vulnerability in the security paradigm which, as it currently exists, is particularly susceptible to being compromised by so called man-in-the middle attacks.

### SUMMARY

This Summary is provided to introduce a selection of concepts in a simplified form that are further described below in the Detailed Description. This Summary is not intended to identify key features or essential features of the claimed subject matter, nor is the Summary to be used as an aid in determining the scope of the claimed subject matter.

In one aspect, the present disclosure is generally directed to a hardware token for completing an out-of-band authentication. In one embodiment, the hardware token performs a method that comprises: receiving an out-of-band encryption key from a client computing device; deriving a security credential that uniquely identifies the hardware token; transmitting the derived security credential and received out-of-band encryption key over the out-of-band communication channel to a network backend over a wireless network; receiving an in-band encryption key over the out-of-band communication channel; and transmitting the received in-band encryption key to the paired client computing device.

### DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a block diagram illustrating a “two-factor” authentication system currently implemented in a number of environments;

FIG. 2 is a block diagram illustrating another “two-factor” authentication system currently implemented in a number of environments;

FIG. 3 is a general block diagram of an exemplary hardware token in accordance with some embodiments of the disclosed subject matter;

FIG. 4 is a pictorial depiction of a hardware token configured to perform a secure out-of-band authentication in accordance with embodiments of the present disclosure;

FIG. 5 is a pictorial depiction of a hardware token configured to perform a secure out-of-band authentication in accordance with embodiments of the present disclosure;

FIG. 6 is a pictorial depiction of a hardware token configured to perform a secure out-of-band authentication in accordance with embodiments of the present disclosure;

FIG. 7 is a pictorial depiction of a hardware token configured to perform a secure out-of-band authentication in accordance with embodiments of the present disclosure;

FIG. 8 is a pictorial depiction of a hardware token configured to perform a secure out-of-band authentication in accordance with embodiments of the present disclosure;

FIG. 9 is a flow diagram illustrating a method configured to perform a secure key exchange in accordance with embodiments of the present disclosure;

FIGS. 10A-C are diagrams of hardware tokens that illustrate various aspects of the present disclosure; and

FIGS. 11A-C are diagrams of hardware tokens that illustrate additional aspects of the present disclosure.

### DETAILED DESCRIPTION

The description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

The present disclosure is generally directed to systems, methods, and devices operable to securely authenticate users and better address the security needs of an increasingly connected and mobile society. As will become apparent from the description that follows, the present disclosure includes a number of aspects for more securely authenticating users in various environments. In an illustrative embodiment, both “in-band” and “out-of-band” communications systems may be employed to separately communicate security credentials associated with a user. For example, upon initiating a transaction request, security credentials that represent the knowledge authentication factor (username, password, PIN, etc.) may be communicated to a service provider via an in-band communication system. On the other hand, security credentials that represent the possession authentication factor (i.e. OTP, digital certificate, etc.) may be communicated via an out-of-band communication system in a way that is entirely separate from the in-band communication. By utilizing an out-of-band communication method directly from a hardware token to communicate security credentials as described herein, the present disclosure is able to virtually eliminate threats posed by entire classes of malware and more securely authenticate users.

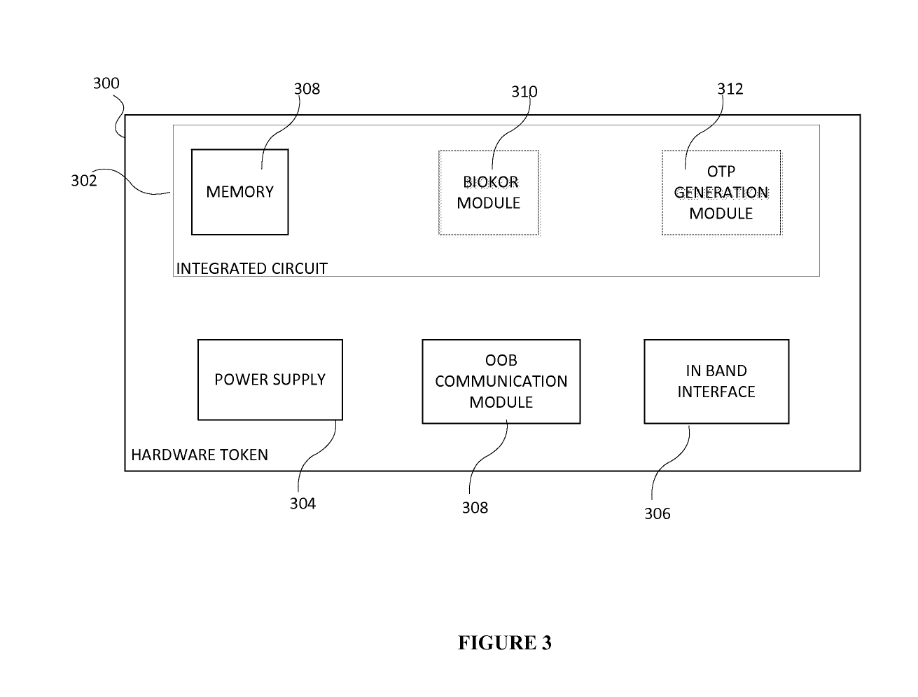

Now with reference to FIG. 3, a first illustrative embodiment of a hardware token 300, such as a smart card, capable of completing an out-of-band authentication in accordance with aspects of the present disclosure will be described. In the exemplary block diagram illustrated in FIG. 3, the hardware token 300 includes the integrated circuit 302, a power supply 304, an in-band interface 306, and an out-of-band (“OOB”) communication module 308. As described in more detail below, the hardware token 300 is configured to communicate with an authentication backend utilizing the OOB communication module 308. In one embodiment, the hardware token 300 is a wireless smart card that employs the OOB communication module 308 to transmit an authentication message using a variety of protocols and wireless communication methods such as cellular, Wi-Fi, Bluetooth, Near Field Communications (NFC), and combinations thereof. Regardless of the communication method and in accordance with one embodiment, the present disclosure provides a secure method of completing an out-of-band authentication between the hardware token 300 and a network backend utilizing the OOB communication module 308.

The hardware token 300 may be further configured to be compatible with the existing in-band payment and physical/logical access infrastructure (ATM machines, point-of-sale readers and interrogators, etc.). In this regard, the hardware token 300 may include the in-band interface 306 which utilizes the appropriate technology for interacting with the existing authentication infrastructure. By way of example only, the in-band interface 306 may include various in-band technologies and communication methods such as a magnetic stripe, an EMV chip, a QR code display, an NFC component and/or any other similar technology.

In the embodiment illustrated in FIG. 3, the hardware token 300 includes the internal power supply 304 which may be comprised of a battery, super-capacitor, and/or piezo electric component. As will be clear in the description below, the hardware token 300 may include one or more active components that utilizes a specified amount of power. In instances when a certain amount of power is needed, the hardware token 300 may be configured with an internal power supply 304 that provides power to other components of the hardware token. In other embodiments, the hardware token 300 is configured without an internal power supply. In this instance, the hardware token 300 may be comprised of passive components that do not require an internal power source and/or power is obtained or otherwise harvested from an external source. By way of example, one skilled in the art and others will recognize that both contact (e.g. ISO/IEC 7810) and contactless (e.g. NFC) point-of-sale terminals may be utilized to supply power to the hardware token 300. Moreover, the hardware token 300 may also harvest energy from an external source utilizing a piezo electric effect. In some instances, the energy obtained from the external source is sufficient to power the hardware token 300 thereby negating the use of an internal power supply. In other instances, the energy harvested from the external source is used to supply power and recharge the internal power supply 304. In this instance, a smaller and more cost-effective internal power supply 304 would be sufficient to provide power to other components of the hardware token 300.

As further depicted in FIG. 3, the hardware token 300 further includes the integrated circuit 302 which may be any number of different types of circuits such a general purpose processor, a special purpose processor, a digital signal processor (DSP), a controller (such as a memory controller), a microcontroller, Application Specific Integrated Circuit (ASIC), biometric processor or co-processor, Field Programmable Gate Array (FPGAs), a System-on-Chip (SOC), or any other type of substantially similar chip package. In the exemplary embodiment depicted in FIG. 3, the integrated circuit 302 includes an internal memory 308 which may be comprised of various types of memory.

In the embodiment of the present disclosure depicted in FIG. 3, the integrated circuit 302 includes the BioKor module 310 and the OTP generation module 312. In one embodiment of the present disclosure, the hardware token 300 implements so-called ‘match-on-card’ functionality for authenticating a user's biometric data. In this instance, the hardware token 300 may include an embedded fingerprint sensor for capturing a user's biometric data. In other instances, the user's biometric data is obtained using a different type of sensor or obtained and provided to the hardware token by a communicatively connected device. In the embodiment illustrated in FIG. 3, the BioKor module 310 implements the image filtering and pattern matching logic that determines whether incoming biometric data is authentic. A more detailed explanation of a hardware-based biometric module (e.g. the BioKor module 310) can be found in the following commonly assigned, co-pending U.S. Patent Application No. 61/863,786 filed Aug. 8, 2013 entitled “SCALABLE HIERARCHICAL MICROARCHITECTURE” which is incorporated herein by reference. In alternative embodiments, a firmware-based biometric solution is implemented that utilizes a microprocessor and software to authenticate a user's biometric data. As described in further detail below, a user's biometric data may not be verified in other embodiments of the present disclosure.

In an additional aspect of the present disclosure, the hardware token 300 provides data verifying at least the possession of the hardware token 300 to an authentication backend. To prevent spoofing, aspects of the present disclosure may authenticate at least possession of a specific hardware token by generating an OTP and/or providing a signed digital certificate to an authentication backend. For example, upon a user activating a button, entering a PIN, or having their biometric data verified on the hardware token, the OTP generation module 312 may generate an OTP that is communicated to an authentication backend and verified. While the embodiment in FIG. 3 depicts an OTP generation module 312, other methods of verifying a specific hardware token such as a digital certificate may be employed without departing from the scope of the claimed subject matter.

It should be well understood that the depictions and descriptions provided with reference to FIG. 3 should be construed as exemplary. In actual embodiments, the architecture of the hardware token 300 provided by the present disclosure may include additional or fewer components than those depicted in FIG. 3 and/or may be configured in alternative arrangements than described. Depending on the specific application, the hardware token 300 may and typically will include other components and functional blocks than depicted in FIG. 3. In addition, some of the functionality of the hardware token 300 described herein may be implemented in a single component or may be integrated into disparate and multiple components depending on the specific needs of a particular application without departing from the scope of the claimed subject matter.

General purpose platforms such Windows, Android, and IOS, are particularly hospitable to malware. These platforms support an architecture convenient to developers but which also allows hackers to exploit weak points or vulnerabilities in security and obtain unauthorized access. Aspects of the present disclosure are configured to eliminate certain vulnerabilities by securely generating security credentials on a hardware token and communicating these security credentials via an out-of-band communication channel. The security credentials are stored, generated, or otherwise maintained in a way that is separate from unavailable to remote devices. Moreover, aspects of the present disclosure eliminate other types of vulnerabilities and protect users and service providers from the exploits of black hat actors. One skilled in the art and others will recognize that a number of combinations and variations of the functionality described below are possible without departing from the scope of the claimed subject matter.

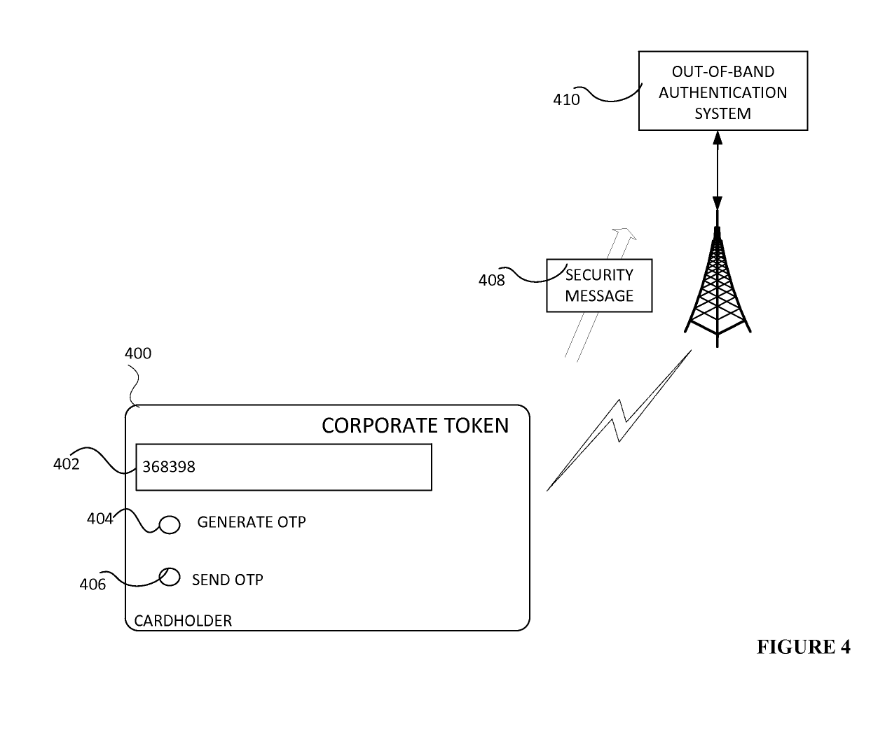

An exemplary embodiment of the present disclosure is illustrated and will be described now with reference to FIG. 4. In this regard, FIG. 4 depicts a hardware token 400 that is configured to perform a secure out-of-band authentication and may have a component architecture as described with reference to FIG. 3, above. While some of the descriptions provided herein utilize wireless smart cards as the exemplary hardware token, one skilled in the art will recognize that smart cards are merely one type of hardware token. The exemplary embodiment depicted in FIG. 4 is of a wireless smart card 400 that is configured with a secure element (i.e. the integrated circuit 302) and an OOB communication module 308 to allow secure communications between the wireless smart card 400 and a network backend. The wireless smart card 400 is configured to communicate and potentially receive data over a wireless network such as a cellular-based wireless network or Wi-Fi network to, among other things, complete an out-of-band authentication.

In the embodiment illustrated in FIG. 4, the wireless smart card 400 includes a display 402, a first button 404 (“GENERATE OTP”), and a second button 406 (“SEND OTP”). The user may generate an OTP by pressing the first button 404. Upon activation, the wireless smart card 400 may initiate a power up procedure in which the device transitions from a low or no power state to a state suitable for wireless communication with a remote device. Then, and in accordance with one embodiment, an OTP suitable for being derived and authenticated at a network backend may then be calculated by the wireless smart card 400 and optionally presented on the display 402. In this example, the user may then activate the second button 404 to transmit a security message 408 containing the OTP to the out-of-band authentication system 410. The out-of-band authentication system 410 is configured to authenticate the OTP and allow a desired transaction or logical access to continue assuming that the users' credentials are authentic.

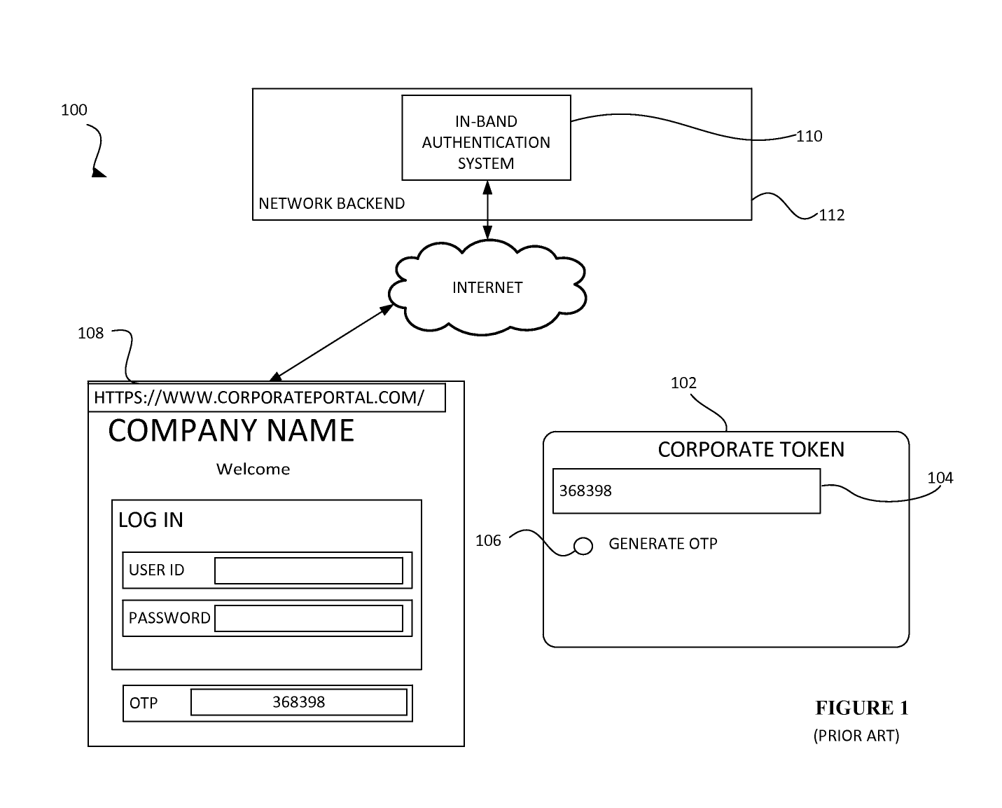

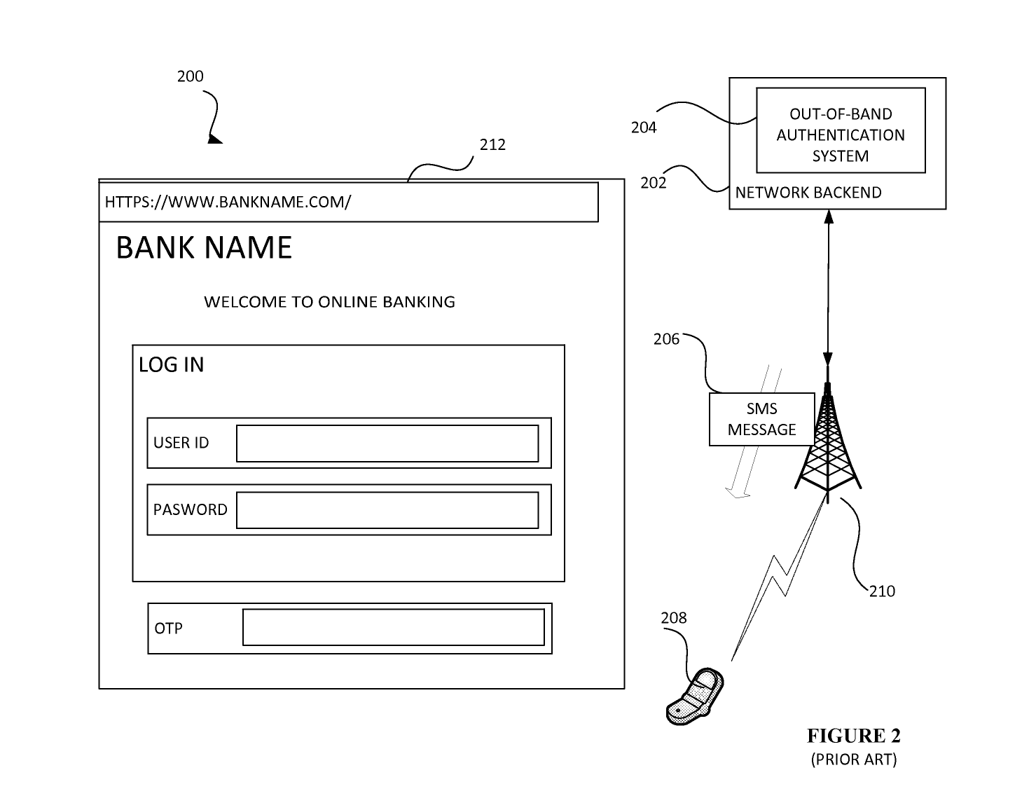

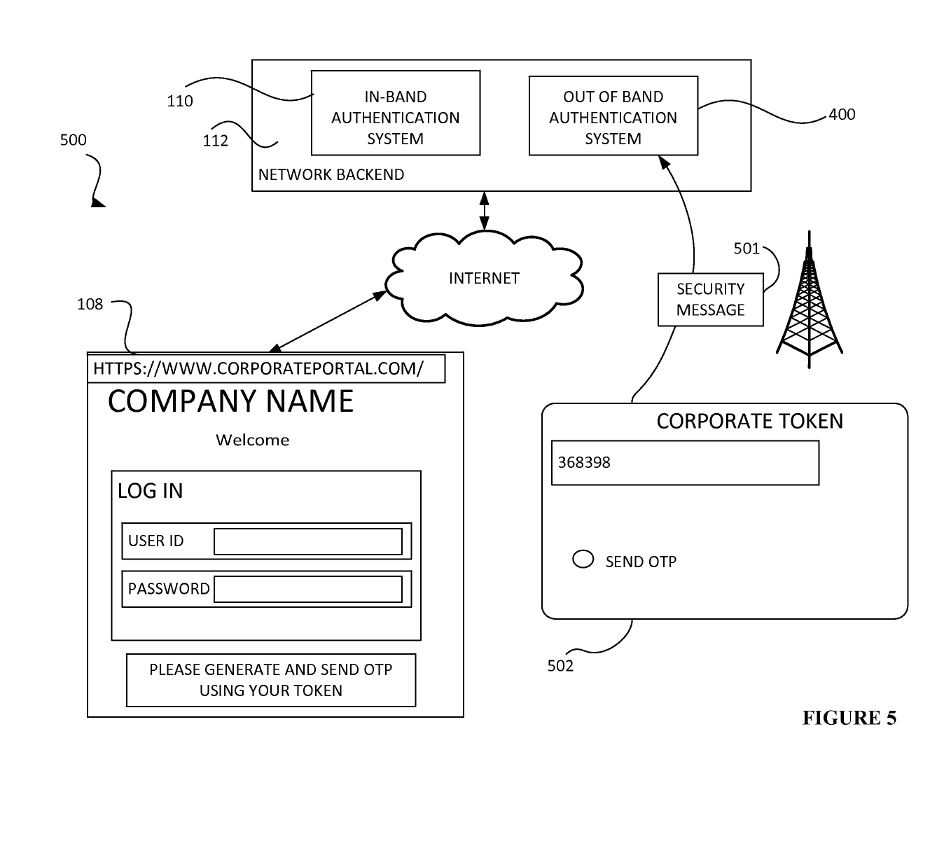

An exemplary embodiment of the present disclosure is illustrated and will be described with reference to FIG. 5. In this regard, FIG. 5 illustrates a system 500 in a user performs a login to a corporate portal as was depicted and described with reference to FIG. 1. Similar to the description provided above, the user may initiate a login by entering the requested credentials (e.g. username and password) and cause these credentials to be transmitted to the network backend 112 via the in-band communication channel. In response, the user may be directed by the login page 108 or other mechanism to generate an the security message 501 on the wireless smart card 502 for encrypted transmission to the network backend 112 and the out-of-band authentication system 400 (FIG. 4). If the credentials transmitted across both the in-band and out-of-band communication channels are identified as genuine, then the user is authenticated and the login to the corporate portal will typically be successful. One skilled in the art will recognize that the increased authentication security that the wireless smart card 502 provides when compared to existing systems. Among other things, the so-called man in the middle attacks described above with reference to FIGS. 1-2 would be prevented by using methods enabled by the wireless smart card 502. In addition, data uniquely associated with the wireless smart card 502 beyond the OTP may also be authenticated thereby insuring that a specific user's wireless smart card was used to transmit a particular security message. Beneficially, the authentication methods described herein are largely compatible with the existing authentication infrastructure.

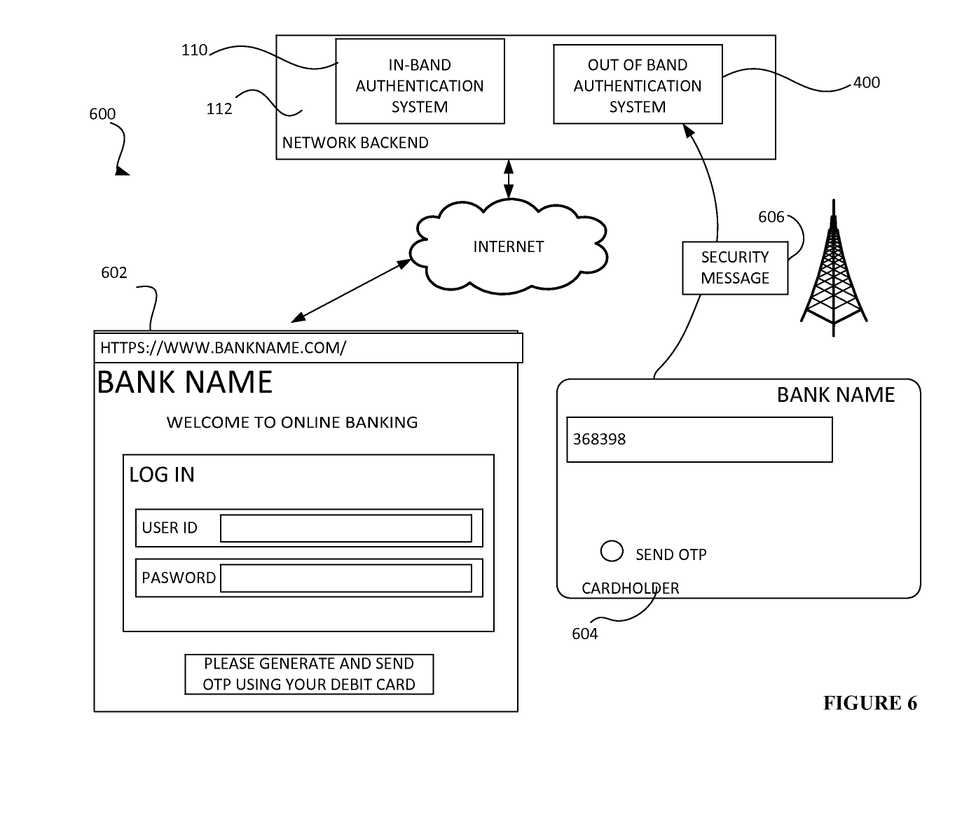

It should be well understood that the description provided with reference to FIG. 5 should be construed as merely once instance where aspects of the present invention may be utilized to authenticate a user and users may be authenticated in other contexts than the specific examples described herein without departing from the scope of the claimed subject matter. By way of example, FIG. 6 illustrates a system 600 in which a user performs a login to an online bank account. In this regard, FIG. 6 includes virtually the same components as was depicted and described with reference to FIG. 5 above. Similar to the previously described logical access, the user may initiate a login by entering the requested credentials (e.g. username and password) into the login page 602. These credentials are transmitted to the network backend 112 via the in-band communication channel. In response, the user may be directed by a dialog box or other mechanism to activate the wireless smart card 604 and generate the security message 606 for encrypted transmission to the network backend 112 and the out-of-band authentication system 400 (FIG. 4). If the credentials transmitted across both the in-band and out-of-band communication channels are identified as genuine, then the user is authenticated and the login to the bank account is successful.

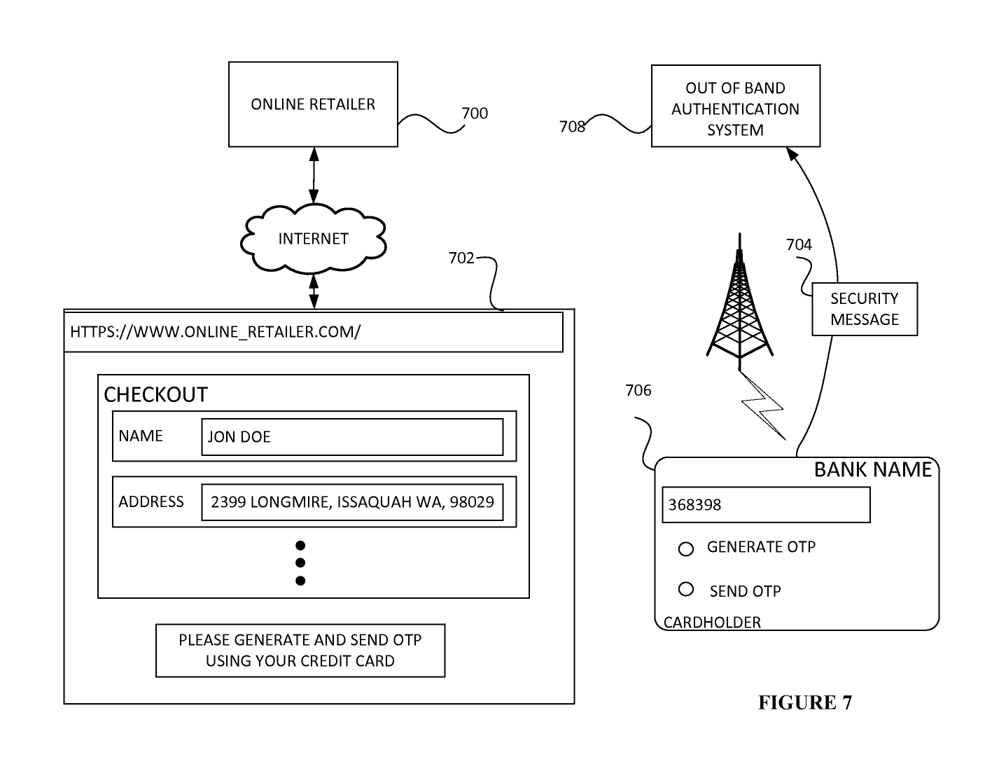

Another application of the present disclosure will now be described with reference to FIG. 7. One of the largest areas of growth in financial transaction fraud involves card-not-present fraud which most commonly involves the theft of genuine card details that are then used to make a purchase over the Internet, by phone, or by mail order. In general, the difficulty in countering this type of fraud lies in the fact that neither the card nor the cardholder must be present when the transaction occurs. Card-not-present fraud accounts for more than half of all card fraud and will continue to grow as EMV (EuroPay, MasterCard, Visa) security measures become more widely adopted at the point-of-sale. In the embodiment illustrated in FIG. 7, aspects of the present disclosure are implemented in the context of a credit/debit transaction. In this regard, FIG. 7 illustrates a checkout procedure of completing a purchase at an online retailer 700. The user may finalize the transaction by entering the requested credentials into the Web page 702 and causing these credentials to be transmitted to the online retailer 700 via the Internet (in-band). Similar to the description provided above, the user may be directed by a dialog box or other mechanism to generate and send a security message 704 from the wireless smart card 706 for encrypted transmission to the out-of-band authentication system 708. The online retailer 700 will typically cause an authorization request to be transmitted to an issuing bank using the existing payment network (not shown). If the credentials transmitted across both the in-band and out-of-band communication channels are identified as genuine, then the transaction may be authenticated. Of course, use of the present disclosure is not limited to preventing card-not-present fraud and the out-of-band authentication method described herein is equally applicable to point-of-sale transactions where the cardholder is present.

It should be well understood that the description provided with reference to FIG. 7 should be construed as merely once instance where aspects of the present invention may be utilized to authenticate a user in the context of a credit or debit transaction. An issuing bank or merchant may determine that transmission of a security message using the wireless smart card 706 is not cost-effective for authorizing every credit or debit card transaction. In general, the issuing bank and/or merchant may require an out-of-band authentication at any time deemed necessary.

In some of the description provided herein, the Short Messaging Service (SMS) is used as an exemplary protocol to transmit data from a hardware token. SMS has a number of benefits including being extremely inexpensive when compared to other wireless communication protocols. However, SMS suffers from the disadvantage that the communication protocols lacks certain security measures and message delivery is not guaranteed. Accordingly, in one embodiment, hardware tokens provided by the present disclosure are configured to communicate using alternative communication protocols such as Unstructured Supplementary Service Data (USSD). Unlike Short Message Service (SMS) messages, USSD messages create a real-time connection during a USSD session. The connection remains open, allowing a two-way exchange of a sequence of data. This makes USSD more responsive, secure, and can enable additional functionality. For example, in a USSD session, challenge/response messages may be transmitted from a provider such that the wireless smart card may be prompted for a variety of security credentials. One skilled in the art and others will recognize that additional or alternative wireless communication protocols beyond SMS and/or USSD may be utilized by the present disclosure without departing from the scope of the claimed subject matter.

In a number of embodiments of the present disclosure, a hardware token is provided that is configured for contactless or contact-based communication with a proximately located computing device which may be a traditional personal computer, tablet computer, mobile phone, and the like. Moreover, a hardware token is provided that may be configured for contactless or contact-based communication with a proximately located attachment or accessory to a computing device. By way of example only, the out-of-band (“OOB”) communication module 308 (FIG. 3) may enable a wireless smart card provided by the present disclosure with wireless Bluetooth or NFC functionality for short range wireless communication with a paired computing device (mobile phone, tablet, personal computer, etc.). In these and other embodiments, the present disclosure may implement systems, methods, and devices for secure key exchange between the hardware token, paired computing device/attachment, and the network backend, as described in further detail below.

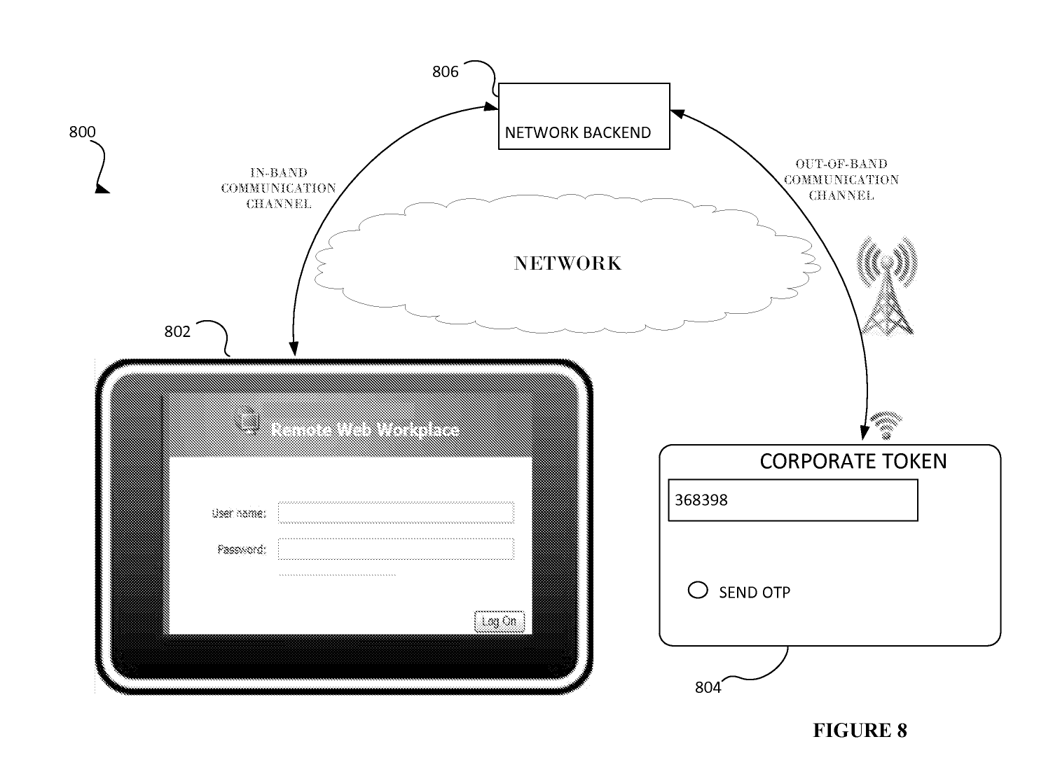

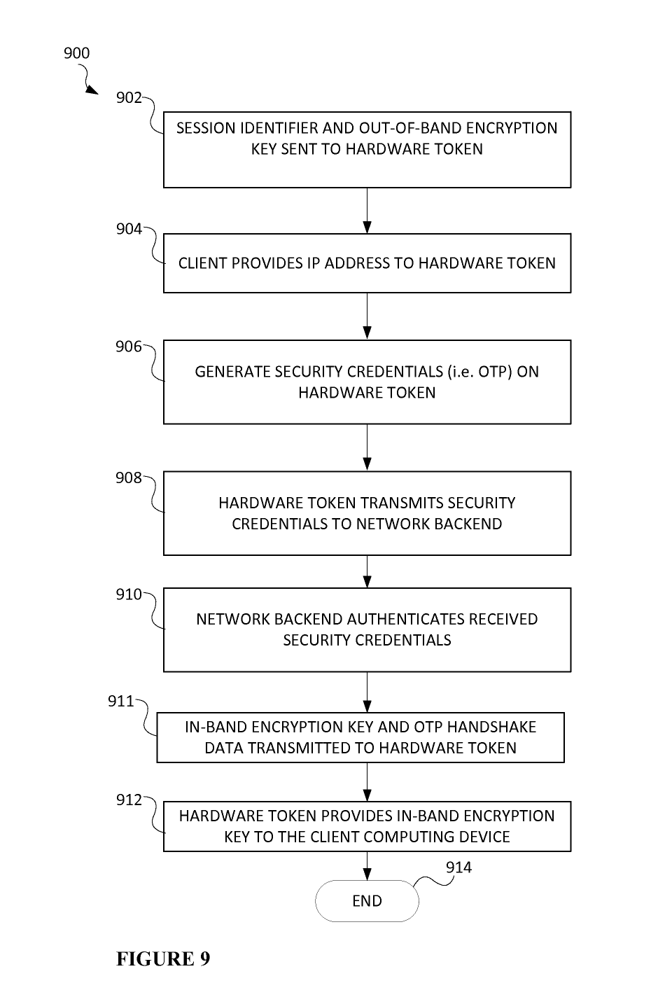

Now with reference to FIGS. 8 and 9, various aspects of the present disclosure for completing a secure key exchange between multiple devices in authenticating a user will be described. As depicted in FIG. 8, the system 800 may include a computing device 802, a hardware token 804, and a network backend 806 responsible for authenticating a user's credentials. One skilled in the art will recognize that the computing device 802 may be any general purpose computing devices. As mentioned above, various transaction requests for access may result in security credentials (i.e. username, password, credit card number, OTP, digital certificate, etc.) being transmitted either in-band from the computing device 802 or out-of-band from the hardware token 804 to the network backend 806. To insure the integrity of data transmitted from the various devices, the security credentials should be encrypted in transit. Moreover, keys used for data encryption between the various devices should be securely exchanged in a way that prevents intervening devices and black hat actors from intercepting this sensitive data.

Now with reference to FIG. 9, a method 900 of securely exchanging encryption keys and other identifying information to secure an authentication session in accordance with various embodiments of the present disclosure will be described. For illustrative purposes, the method 900 is described in the context of the system 800 and the various devices mentioned above with reference to FIG. 8. To improve current encryption schemes, an additional encryption key variable can be made non-observable through the use of out-of-band transmission technology. In this regard, an encryption protocol is provided where a public key is not observable to any agents that snoop the in-band communication channel.

As shown in FIG. 9, the method 900 begins at block 902 where a session identifier and out-of-band encryption key are generated at the network backend 806 by an authentication authority and transmitted to a hardware token associated with a user (i.e. the hardware token 804). The session identifier and out-of-band encryption key may be encrypted and transmitted in-band from the network backend 806 to the client computing device (i.e. the computing device 802) and then to the hardware token, at block 902. Then, at block 904, the client computing device 802) provides the paired hardware token 804 with the client's IP address.

At block 906 of the method 900, certain security credentials (i.e. OTP, digital certificate, etc.) are generated or accessed on the hardware token 804. In an exemplary embodiment, a time-synchronous OTP is calculated on the hardware token 804, at block 906. However, in other embodiments, the security credentials generated on the hardware token 804 are not limited to an OTP and may be another type of security credential such as a digital certificate. As used herein the term “OTP” refers to all of the different possible technologies suitable for authenticating the possession of a specific hardware token.

At block 908 of the method 900, the hardware token 804 causes certain security credentials and data to be transmitted directly from the hardware token 804 to the network backend 806. In one embodiment, the security credentials and data transmitted, at block 908 includes the OTP (generated at block 906), the clients IP address (obtained at block 904), and a unique token identifier loaded on the specific hardware token 804. The OTP, token identifier, and out-of-band encryption key may be encrypted and transmitted out-of-band directly from the hardware token 804 to the network backend 806 without being exposed on the in-band communication channel. In this regard, the hardware token 804 is configured to communicate with the network backend 806 using the out-of-band encryption algorithm/key that was previously sent to the client computing device's 802 IP address and supplied to the hardware token 804.

At block 910 of the method 900, the security credentials and data sent at block 908 are authenticated at the network backend 806. Assuming the received data is authentic, OTP handshake data and an in-band encryption key are generated at the network backend 806, at block 911 and transmitted to the hardware token 804. The OTP handshake data and in-band encryption key may be encrypted and transmitted out-of-band from the network backend 806 to the to the hardware token 804, at block 911. Then, at block 912, the hardware token 804 transmits the received in-band encryption key to the client computing device 802.

Once the in-band and out-of-band encryption keys have been exchanged and the security credentials have been authenticated, any further communications between the network backend 806 and the client computing device 802 may be encrypted using the in-band encryption key. Similarly, any further communications between the network backend 806 and the hardware token 802 may be encrypted using the out-of-band encryption key. In instances when the user is not authenticated, processing to handle the failed authentication attempt is performed such that, for example, either the attempt to authenticate the user is repeated or the transaction is declined. Then, the method 900, proceeds to block 914, where it terminates.

It should be well understood that the depictions and descriptions provided with reference to FIGS. 8-9 should be construed as exemplary. For example, the functionality depicted and described with reference to FIG. 9 is made in the context of a process flow diagram where steps are performed in a particular order. However, at least some of the steps can be performed in a different order and/or certain steps may be added/removed without departing from the scope of the claimed subject matter. Accordingly, the ordering and number of steps provided above with reference to FIG. 9 should also be construed as exemplary and not limiting.

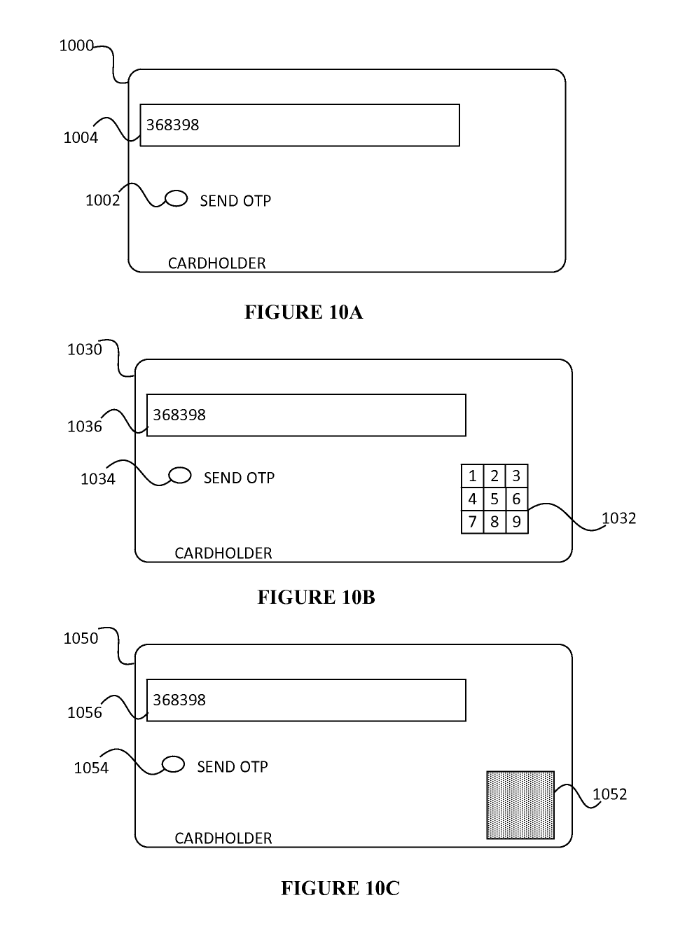

Now with reference to FIGS. 10A-C additional configurations of hardware tokens provided by the present disclosure that are configured to perform secure communications with a service provider will be described. In this regard, FIG. 10A depicts a wireless smart card provided by the present disclosure in a basic form having a single button 1002 (“SEND OTP”). Upon activation of the button 1002, the wireless smart card 1000 may initiate a power up procedure, generate an OTP, and send the OTP (or other authorization code) to the network backend over an out-of-band communication channel in ways described previously. Optionally, an OTP may also be presented on the display 1004. The wireless smart card 1000 depicted in FIG. 10A has the advantage of being easy to use as well as inexpensive to manufacture.

Another wireless smart card 1030 provided by the present disclosure is depicted in and will be described with reference to FIG. 10B. The wireless smart card 1030 depicted in FIG. 10B includes a keypad 1032 for text entry, an optional button 1034 (“SEND OTP”), and an optional display 1036 suitable for presenting characters to the user. In some instances, providers may want the security of requiring entry of a PIN that is a secret value which should only be known by the authorized user. Accordingly, in one configuration, a user enters their PIN using the keypad 1032. If the PIN is authentic, than the wireless smart card 1030 generates an OTP which may be presented on the display 1036. Similar to the descriptions provided above, the OTP may then be sent to the network backend upon activation of the button 1034. In some financial networks such as debit card networks, transmission and authorization of the PIN number may be required by the a remote service provider. In this and other instances, the PIN entered by the user may be transmitted to the remote service provider using either the in-band or out-of-band authentication channels, as appropriate. In this instance, transmission of the OTP in addition to the PIN may or may not be necessary depending on the requirements of the service provider and the financial network being used. The hardware tokens provided by the present disclosure may be configured in any number of ways to meet the needs of the service provided and applicable financial network.

Now with reference to FIG. 10C another configuration of a wireless smart card 1050 provided by the present disclosure will be described. The wireless smart card 1050 depicted in FIG. 10C includes a fingerprint sensor 1052 for capturing a fingerprint image, an optional button 1054 (“SEND OTP”), and an optional display 1056. In some instances, providers may want the additional security of requiring biometric authentication of a user before authorizing a transaction. Accordingly, in one configuration, a user will press or swipe their finger on the fingerprint sensor 1052. The wireless smart card 1050 is configured to compare the captured fingerprint image to a template associated with an authorized user, as described above with reference to FIG. 3. If the fingerprint is identified as being authentic, than the wireless smart card 1050 generates an OTP which may be presented on the display 1056. Similar to the description provided above, the OTP may be sent to a remote provider upon activation of the button 1054 or automatically without in further input from the user. Alternatively, the OTP could also be entered into an in-band authentication system.

Increasingly, financial commerce is seen as being centered on a user's “mobile wallet” which most commonly refers to one or more applications executing on a mobile phone and/or in the “cloud.” Similar to a physical wallet, the mobile wallet contains users' most important credentials including but not limited to identity, affiliation, payment, and personal information. It is also a repository that includes a record of users purchases and preferences. Some “mobile wallet” payments systems and/or networks rely on QR codes (“Quick Response Codes”) which is a type of two-dimensional bar code that is machine-readable. The QR Code system has become popular due to its fast readability and greater storage capacity compared to standard UPC barcodes and can be configured to represent virtually any type of data. Increasingly, mobile phones are configured with the ability to both display QR codes as well as scan QR codes printed on various items. The data represented in a QR code may represent a user's sensitive financial information such as name, address, credit card number, etc. If a QR code representing this type of data is captured by a malicious user, it may be used to commit various types of fraud.

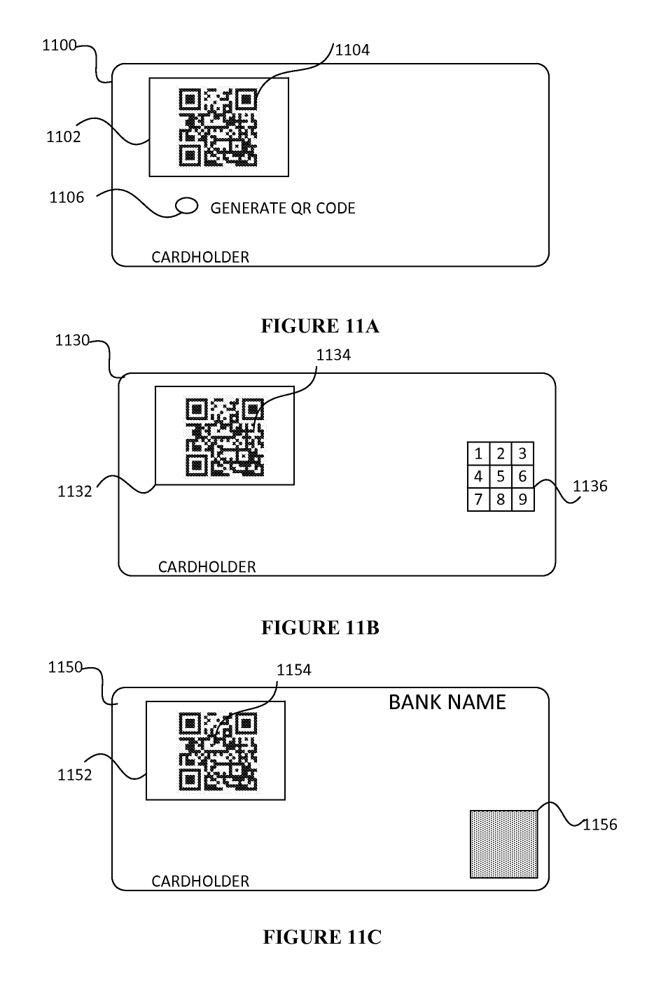

Now with reference to FIGS. 11A-C additional hardware tokens provided by the present invention will be described that enables secure use of QR codes. In this regard, FIG. 11A depicts a smart card 1100 provided by the present disclosure that includes a display 1102 for selectively displaying a QR code 1104, and a button 1106 (“GENERATE QR CODE”). Upon activation of the button 1106, the QR enabled smart card 1100 may initiate a power up procedure and display the QR code 1104 suitable for scanning by a QR code reader. A user's account information used to complete a transaction or security information will typically be embedded in the QR code 1104 that is selectively presented on the display 1102. The display 1102 will typically cease presenting the QR code 1104 on completion of a transaction, after a predetermined period of time, or upon receiving the appropriate input from the user (by, for example, the user activating the button 1106 again). Once the QR code 1104 is no longer presented on the display 1102, the smart card 1100 may then proceed into a reduced power state. By selectively displaying the QR code 1104, the smart card 1100 provides improved security as QR codes are typically presented in printed form and therefore readily captured by any number of commonly available devices including mobile phones. Also, the smart card 1100 enables users to securely participate in QR based transactions without having a ‘smart phone’ which can be both expensive and insecure.

Another QR enabled smart card 1130 provided by the present disclosure is depicted and will be described with reference to FIG. 11B. The smart card 1130 depicted in FIG. 11B includes a display 1132 for selectively displaying a QR code 1134 and a keypad 1136 for text entry. In this embodiment, a user enters their PIN number into the smart card 1130 using the keypad 1136. If the PIN is authentic, than the smart card 1130 displays the FIGUREQR code 1134 on the display 1132 suitable for scanning by a reader. A user's account information used to complete a transaction or security data will typically be embedded in the QR code that is selectively presented on the display 1132. The QR code 1134 will typically cease being presented on the display in the same instances as described above with reference to FIG. 11A. In this way, the smart card 1130 depicted in FIG. 11B adds an extra layer of security that prevents transactions from being completed using the smart card 1130 without the appropriate PIN.

Now with reference to FIG. 11C another configuration of a QR enabled smart card 1150 provided by the present disclosure will be described. The smart card 1150 depicted in FIG. 11C includes a display 1152 for selectively displaying a QR code 1154 and a fingerprint sensor 1156 for capturing a user's biometric data. Accordingly, in one configuration, a user will press or swipe their finger on the fingerprint sensor 1156. The smart card is configured to compare the captured fingerprint image to a template associated with an authorized user as described above. If the fingerprint is identified as being authentic, than the smart card 1150 generates and presents the QR code 1154 on the display 1152. In this way, the smart card 1150 depicted in FIG. 11C adds an extra layer of security that prevents transactions from being completed unless a user is biometrically authenticated.

It should be well understood that the functionality of the hardware tokens depicted and described with reference to FIGS. 10A-C is not mutually exclusive from the functionality of the QR enabled hardware tokens depicted and described with reference to FIGS. 11A-C. For example, the QR enabled smart cards described with reference to FIGS. 11A-C may be configured to transmit any authorization data (OTP, PIN, etc.) in an SMS message to an out-of-band authentication system. One skilled in the art will recognize that a variety of card configurations and authentication methodologies are enabled by aspects of the present disclosure and the examples described herein should be construed as exemplary.

While the preferred embodiment of the present disclosure has been illustrated and described, it will be appreciated that various changes can be made therein without departing from the spirit and scope of the disclosed subject matter.

1. A hardware token configured to execute a method for completing an out-of-band authentication, the method comprising:
receiving an at least an out-of-band encryption key from a client computing device;
deriving a security credential that uniquely identifies the hardware token;
transmitting at least the derived security credential and received out-of-band encryption key over the out-of-band communication channel to a network backend over a wireless network;
receiving at least an in-band encryption key over the out-of-band communication channel; and
transmitting the received in-band encryption key to the paired client computing device.

2. The method as recited in claim 1, wherein subsequent data exchanged between the client computing device and the network backend is encrypted using the in-band encryption key and wherein data exchanged between the hardware token and the network backend is encrypted using the out-of-band encryption key.

3. The method as recited in claim 1, wherein deriving a security credential that uniquely identifies the hardware token includes generating a One Time Password or accessing a digital signature.

4. The method as recited in claim 1, wherein the hardware token is configured to transmit data utilizing at least one the following types of wireless communication protocols including cellular, Wi-Fi network, Bluetooth, and NFC.
